(19) United States
(12) Patent Application Publication
(10) Pub. No.: US 2021/0279614 A1
(43) Pub. Date: Sep. 9, 2021

(54) ABDUCTIVE INFERENCE APPARATUS, ABDUCTIVE INFERENCE METHOD, AND COMPUTER READABLE RECORDING MEDIUM

(71) Applicant: NEC Corporation, Minato-ku, Tokyo (JP)

(72) Inventor: Daichi KIMURA, Tokyo (JP)

(73) Assignee: NEC Corporation, Minato-ku, Tokyo (JP)

(21) Appl. No.: 17/258,008

(22) PCT Filed: Jul. 6, 2018
(86) PCT No.: PCT/JP2018/025723

§ 371 Date: Jan. 5, 2021

(51) Int. Cl. G06N 5/04

(52) U.S. Cl. CPC G06N 5/041

(57) ABSTRACT

An abductive inference apparatus 10 includes: a data receiving unit 11 that receives observed event data indicating an observed event; a data specifying unit 12 that specifies observed event data that will not be needed from the received pieces of observed event data based on other pieces of observed event data other than the received pieces of observed event data and knowledge data; and a hypothesis generation unit 13 that generates a hypothesis with which the observed event data that has not been specified by the data specifying unit 12 can be derived using the pieces of observed event data that have not been specified by the data specifying unit 12 and the knowledge data.

### TECHNICAL FIELD

The present invention relates to an abductive inference apparatus and an abductive inference method for performing abductive inference, and further relates to a computer readable recording medium that includes a program for realizing the same recorded thereon.

### BACKGROUND ART

Heretofore, attempts have been made to execute abductive inference by computer (see Patent Documents 1 to 4). If the abductive inference is performed by a computer, it is possible to infer various situations based on information obtained from facts. Therefore, the abductive inference by the computer is useful for the situations such as store roll-out plans, criminal investigations, evacuations at the time of disasters, environmental managements, and the like, and it is expected to improve the accuracy of simulation by using the abductive inference.

Also, specifically, in the abductive inference, a valid hypothesis is derived from knowledge (rules) and observed events (obtained facts). For example, it is assumed that “AB (if A holds true, then B holds true)” is present as the knowledge, and “B holds true” is acquired as an observed event. In this case, “A holds true” is obtained as a hypothesis by the inference. Note that, in the following, the abductive inference may also be called “backward inference”. Also, the process of searching A from B is referred to as “tracing back the inference”.

### LIST OF RELATED ART DOCUMENTS

### Patent Document

Patent Document 1: Japanese Patent Laid-Open Publication No. H09-213081
Patent Document 2: Japanese Patent Laid-Open Publication No. H10-333911
Patent Document 3: Japanese Patent Laid-Open Publication No. 2000-242499
Patent Document 4: Japanese Translation of PCT Application No. 2015-502617

### SUMMARY OF INVENTION

### Problems to be Solved by the Invention

Incidentally, normally, the knowledge is set manually in the abductive inference, but the observed events are acquired in a large amount from logs at the time of system operation or the like. Therefore a problem with known abductive inference systems is that the processing time needed for deriving a hypothesis largely increases due to the accumulation of the observed events, that is, logs.

On the other hand, all of the acquired observed events are not necessarily needed in the abductive inference, and unnecessary observed events are present in the acquired observed events. Therefore, if the unnecessary observed events can be specified from the acquired observed events, the foregoing problem can be considered to be solved. However, the known abductive inference systems do not include such a function, and it is difficult to solve the foregoing problem.

An example object of the invention is to solve the foregoing problem and provide an abductive inference apparatus, an abductive inference method, and a computer readable recording medium that enable execution of abductive inference while excluding unneeded observed event data.

### Means for Solving the Problems

To achieve the above-stated example object, an abductive inference apparatus according to an example aspect of the invention includes:

a data receiving unit configured to receive observed event data indicating an observed event;

a data specifying unit configured to specify observed event data that will not be needed from the received pieces of observed event data based on other pieces of observed event data other than the received pieces of observed event data and knowledge data; and

a hypothesis generation unit configured to generate a hypothesis with which the observed event data that has not been specified by the data specifying unit can be derived using the pieces of observed event data that have not been specified by the data specifying unit and the knowledge data.

Also, to achieve the above-stated example object, an abductive inference method according to an example aspect of the invention includes:

(a) a step of receiving observed event data indicating an observed event;

(b) a step of specifying observed event data that will not be needed from the received pieces of observed event data based on other pieces of observed event data other than the received pieces of observed event data and knowledge data; and

(c) a step of generating a hypothesis with which the observed event data that has not been specified in the (b) step can be derived using the pieces of observed event data that have not been specified in the (b) step and the knowledge data.

Furthermore, to achieve the above-stated example object, a computer-readable recording medium according to an example aspect of the invention is a computer-readable recording medium that includes a program recorded thereon, the program including instructions that cause the computer to carry out:

(a) a step of receiving observed event data indicating an observed event;

(b) a step of specifying observed event data that will not be needed from the received pieces of observed event data based on other pieces of observed event data other than the received pieces of observed event data and knowledge data; and

(c) a step of generating a hypothesis with which the observed event data that has not been specified in the (b) step can be derived using the pieces of observed event data that have not been specified in the (b) step and the knowledge data.

### Advantageous Effects of the Invention

As described above, according to the invention, abductive inference can be executed while excluding unneeded observed event data.

### BRIEF DESCRIPTION OF THE DRAWINGS

FIG. 1 is a block diagram illustrating a schematic configuration of an abductive inference apparatus according to a present example embodiment of the invention.

FIG. 2 is a block diagram illustrating a specific configuration of the abductive inference apparatus according to the present example embodiment of the invention.

FIG. 3 is a flow diagram illustrating operations of the abductive inference apparatus according to the present example embodiment of the invention.

FIG. 4 is a diagram illustrating a specific example 1 of step 2 shown in FIG. 3.

FIG. 5 is a diagram illustrating a specific example 2 of step 2 shown in FIG. 3.

FIG. 6 illustrates a directed graph formed by backward inference from an observation P.

FIG. 7 is a diagram illustrating a specific example 3 of step 2 shown in FIG. 3.

FIG. 8 is a diagram illustrating a specific example 4 of step 2 shown in FIG. 3.

FIG. 9 is a block diagram illustrating an example of a computer that realizes the abductive inference apparatus according to the present example embodiment of the invention.

### EXAMPLE EMBODIMENT

### Example Embodiment

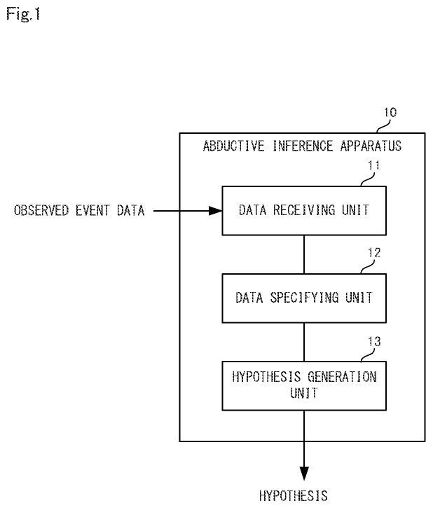

Hereinafter, an abductive inference apparatus, an abductive inference method, and a computer readable recording medium according to the present example embodiment of the invention will be described with reference to FIGS. 1 to 9.

First, the configuration of the abductive inference apparatus according to the present example embodiment of the invention will be described. FIG. 1 is a block diagram illustrating a schematic configuration of the abductive inference apparatus according to the present example embodiment of the invention.

The abductive inference apparatus 10 according to the present example embodiment shown in FIG. 1 is an apparatus for executing abductive inference. As shown in FIG. 1, the abductive inference apparatus 10 includes a data receiving unit 11, a data specifying unit 12, and a hypothesis generation unit 13.

The data receiving unit 11 receives observed event data indicating an observed event. The data specifying unit 12 specifies observed event data that will not be needed (hereinafter denoted as “unneeded observed event data”) from the pieces of observed event data received by the data receiving unit 11 based on pieces of observed event data other than the received pieces of observed event data and knowledge data.

The hypothesis generation unit 13 generates a hypothesis with which observed event data that has not been specified by the data specifying unit 12 can be derived using the pieces of observed event data that have not been specified by the data specifying unit 12 and the knowledge data.

In this way, in the present example embodiment, pieces of observed event data that are not needed in inference are specified from the received pieces of observed event data, and a hypothesis is generated using pieces of observed event data other than those. That is, according to the present example embodiment, the abductive inference can be executed while excluding unneeded pieces of observed event data. As a result, the increase in time needed for deriving a hypothesis due to the accumulation of the observed event data in a large amount can be suppressed.

Also, in the present example embodiment, the data specifying unit 12 can also specify, by executing an analysis on the received pieces of observed event data based on the knowledge data, observed event data that can be derived from the analysis result and the other pieces of observed event data as unneeded observed event data. Also, the data specifying unit 12 can also delete the specified unneeded observed event data.

Moreover, first, the data specifying unit 12 may also perform backward inference on the received observed event data, as the analysis. Here, the data specifying unit 12 can also execute the analysis using the upper-lower relationship in an ontology instead of the backward inference, for example. Next, the data specifying unit 12 can also specify the received observed event data as unneeded observed event data on a condition that, with respect to the obtained inference result, when the inference is traced back from the received observed event data, any of the other pieces of observed event data are necessarily reached.

In addition thereto, the data specifying unit 12 can also specify the received observed event data as unneeded observed event data, if a specific condition is satisfied, on a condition that the received observed event data and an event expected to be observed hold true at the same time. The case where the specific condition is satisfied includes a case where the event expected to be observed has not been observed, and a case where the event expected to be observed cannot be derived by backward inference from another observation based on the knowledge data.

The hypothesis generation unit 13 generates a hypothesis with which observed event data other than the pieces of unneeded observed event data can be derived using the pieces of observed event data other than the pieces of unneeded observed event data and the knowledge data. Also, in the present example embodiment, the hypothesis generation unit 13 can also calculate, when generating the hypothesis, the cost thereof, and select the optimum hypothesis based on the calculated cost.

For example, it is assumed that the following two formulas are present as the knowledge data. Note that the suffixes indicate weights that are assigned to the respective pieces of knowledge data (rules), and indicate the degree of unreliability when abductively inferring the right-hand side from the left-hand side.

Kill(x,y)^{1.4}⇒arrest(z,x)

Kill(x,y)^{1.2}⇒murder(x)

Also, it is assumed that “murder(A)^{$10}”, “police(B)^{$10}”, and “arrest(B,A)^{$10}” have been obtained as pieces of observed event data other than the unneeded observed event data. Note that the suffixes given to pieces of observed event data indicates the cost to be assigned to the respective pieces of observed event data.

In such a case, the hypothesis generation unit 13 generates a hypothesis candidate “Kill(A, u 1)$¹²” from “Kill(x, y)¹²⇒murder(x)” and “murder(A)^{$10}”. Also, the hypothesis generation unit 13 generates a hypothesis candidate “Kill(A, u 2)$¹⁴” also from “Kill(x, y)^{1.4}⇒arrest(z, x)” and “arrest(B,A)^{$10}”. The suffix in each hypothesis candidate is obtained by multiplying the weight of knowledge data and the cost of observed event data, and indicates the cost held by the hypothesis candidate. Thereafter, the hypothesis generation unit 13 selects a hypothesis candidate having the lowest cost from the generated hypothesis candidates, and outputs the selected hypothesis candidate to an external apparatus or the like.

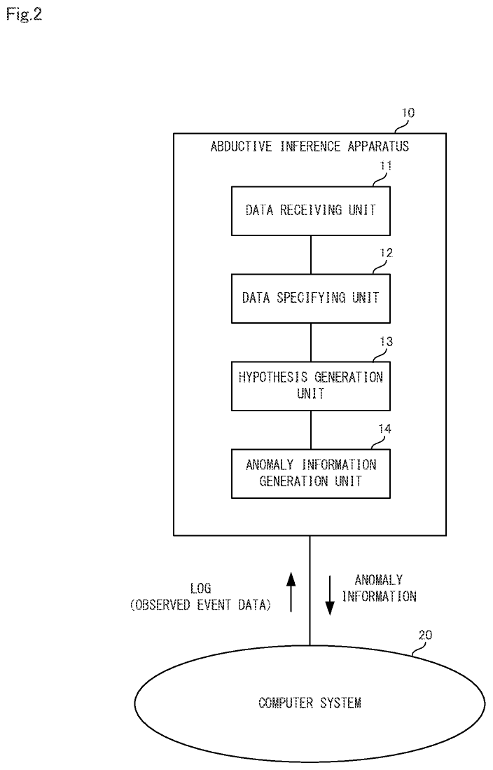

Next, the configuration of the abductive inference apparatus according to the present example embodiment will be more specifically described using FIG. 2. FIG. 2 is a block diagram illustrating the specific configuration of the abductive inference apparatus according to the present example embodiment of the invention.

As shown in FIG. 2, the abductive inference apparatus 10 according to the present example embodiment is connected to a computer system 20 via a network, and functions as a security system of the computer system 20. Therefore, the computer system 20 outputs logs of processing performed therein to the abductive inference apparatus 10.

In the example in FIG. 2, in the abductive inference apparatus 10, the data receiving unit 11 receives logs output from the computer system 20 as observed event data. Also, the data specifying unit 12 specifies a log that will be unneeded (hereinafter, denoted as “unneeded log”) from the received logs based on logs other than the received logs and knowledge data.

Also, the hypothesis generation unit 13 generates a hypothesis with which a log other than the unneeded logs can be derived using logs that have not been specified by the data specifying unit 12, that is, the logs other than the unneeded logs and the knowledge data.

Also, in the example in FIG. 2, the abductive inference apparatus 10 includes an anomaly information generation unit 14. The anomaly information generation unit 14 creates information regarding an anomaly that has occurred in the computer system 20 based on the hypothesis generated by the hypothesis generation unit, and outputs the created information to the outside (e.g., a terminal device of an administrator of the computer system 20, or the like).

For example, it is assumed that the hypothesis generation unit 13 has generated a hypothesis “malware has been received by any of the terminal devices of the computer system 20”. In this case, the anomaly information generation unit 14 generates, as the information regarding an anomaly, information regarding this malware, information regarding the method of removing the malware, or the like.

If the abductive inference apparatus 10 according to the present example embodiment is used as the security system, in this way, abductive inference can be performed by extracting needed logs from the system logs that are generated in a large amount, and therefore an anomaly can be detected quickly and reliably.

[Apparatus Operations]

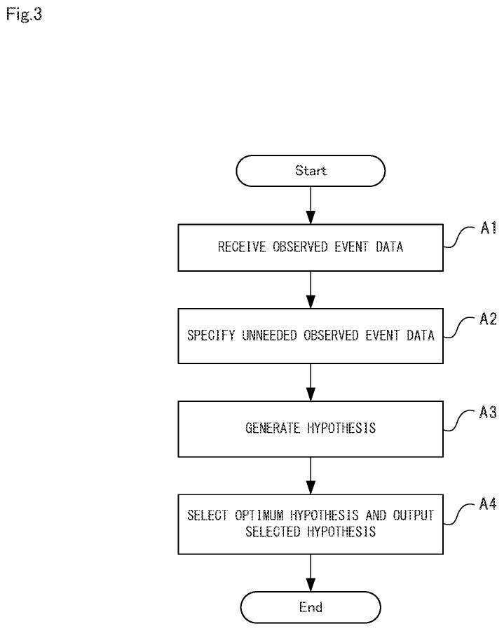

Next, the operations of the abductive inference apparatus 10 according to the present example embodiment will be described using FIG. 3. FIG. 3 is a flow diagram illustrating the operations of the abductive inference apparatus according to the present example embodiment of the invention. In the following description, FIGS. 1 to 6 will be referred to as appropriate. Furthermore, in the present example embodiment, the abductive inference method is carried out by causing the abductive inference apparatus 10 to operate. Therefore, the following description of the operations of the abductive inference apparatus 10 applies to the abductive inference method according to the present example embodiment.

As shown in FIG. 3, first, the data receiving unit 11 receives observed event data indicating an observed event (step A1). The number of pieces of observed event data to be received in step A1 may be one or two or more.

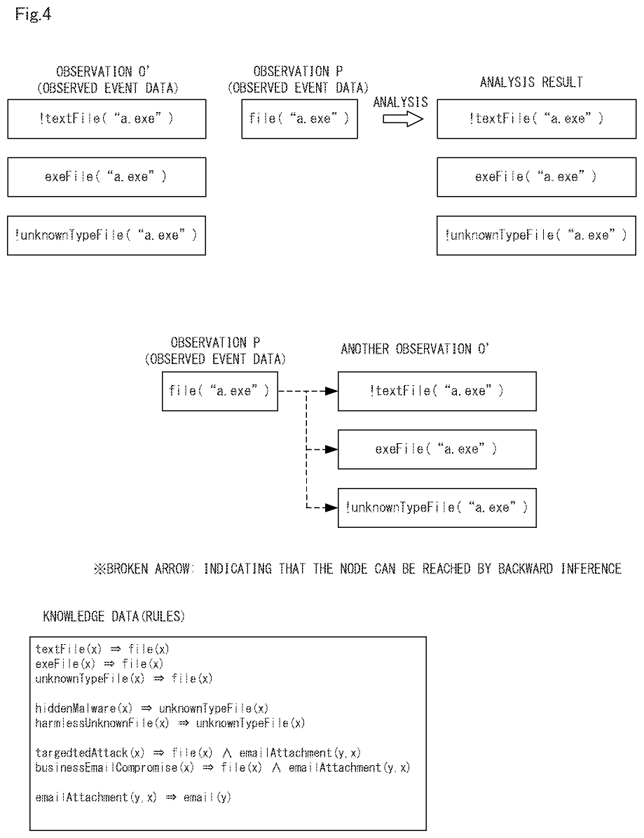

Next, the data specifying unit 12 specifies unneeded observed event data from the pieces of observed event data received in step A1 based on pieces of observed event data other than the received pieces of observed event data and the knowledge data (step A2). Specifically, the data specifying unit 12 executes processing shown in FIGS. 4 to 6 to be described below.

Next, the hypothesis generation unit 13 generates a hypothesis with which observed event data other than the unneeded observed event data can be derived using pieces of observed event data other than the unneeded observed event data specified in step A2 and the knowledge data (step A3). Also, in step A3, the hypothesis generation unit 13 calculates a cost for each generated hypothesis.

Next, the hypothesis generation unit 13 selects an optimum hypothesis from the hypotheses generated in step A3 based on the costs, and outputs the selected hypothesis to the outside (step A4).

### SPECIFIC EXAMPLES

Next, specific examples 1 to 4 of step A2 shown in FIG. 3 will be described using FIGS. 4 to 8. Also, in the following specific examples 1 to 4, it is assumed that the following rules are prepared as the knowledge rule. Moreover, the meanings of predicates of the respective rules will be shown below.

### Knowledge Rule:

textFile(x)⇒file(x)
exeFile(x)⇒file(x)
unknownTypeFile(x)⇒file(x)
hiddenMalware(x)⇒unknownTypeFile(x)
harmlessUnknownFile(x)⇒unknownTypeFile(x)
targedtedAttack(x)⇒file(x)\hat{ }emailAttachment(y,x)
businessEmailCompromise(x)⇒file(x)\hat{ }emailAttachment(y,x)
emailAttachment(y,x)⇒email(y)

### Meanings of Respective Predicates:

file(x): x is a file.
textFile(x): x is a text format file.
exeFile(x): x is an executable file.
unknownTypeFile(x): x is a file in an unknown file format.
hiddenMalware(x): x is hidden malware.
harmlessUnknownFile(x): x is a harmless unknown file.
targedtedAttack(x): x is a targeted attack.
businessEmailCompromise(x): x is a business E-mail compromise.
emailAttachment(y,x): Attachment of E-mail y is x.
email(y): y is an E-mail.

FIG. 4 is a diagram illustrating a specific example 1 of step 2 shown in FIG. 3. In the example in FIG. 4, the data specifying unit 12 executes an analysis on received observed event data based on the knowledge data, and specifies observed event data that can be derived from the analysis result and another observed event data as unneeded observed event data.

Specifically, as shown in FIG. 4, it is assumed that observed event data “file(“a.exe”)” has been observed as an observation P. This observed event data is data (file name: “a.exe”) obtained by various tools such as IDS (Intrusion Detection System) or SIEM (Security Information and Event Management), for example. Also, the observed event data is input to the abductive inference apparatus 10 in a form of logical formula. Also, it is assumed that pieces of observed event data “!textFile(“a.exe”)”, “exeFile(“a.exe”)”, and “!unknownTypeFile(“a.exe”)” have been observed as an observation O′. Here, “!” is used as a symbol indicating negation.

In this case, the data specifying unit 12 acquires “!textFile(“a.exe”)”, “exeFile(“a.exe”)”, and “!unknownTypeFile(“a.exe”)” as the analysis result of the observation P using the above-described knowledge data. Also, in the example in FIG. 4, the literals included in the acquired analysis result is included in the other observation (observed event data) O′ (“!textFile(“a.exe”)”, “exeFile(“a.exe”)”, and “!unknownTypeFile(“a.exe”)”). Therefore, in this case, because the observation P can be derived from the analysis result and another observed event data, the data specifying unit 12 specifies the observation P as unneeded observed event data.

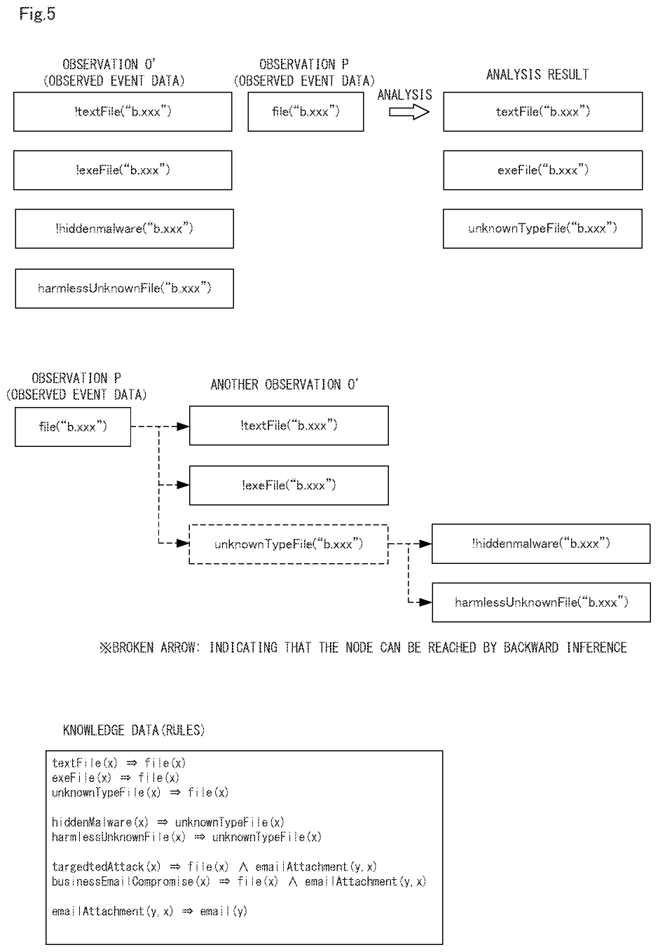

FIG. 5 is a diagram illustrating a specific example 2 of step 2 shown in FIG. 3. In the example in FIG. 5, the data specifying unit 12 first performs backward inference on received observed event data as the analysis. Also, the data specifying unit 12 specifies the received observed event data as unneeded observed event data on a condition that, with respect to the obtained inference result, when the inference is traced back from the received observed event data, any of the other pieces of observed event data are necessarily reached.

Specifically, in the example in FIG. 5, it is assumed that “file(“b.xxx”)” has been observed as an observation P, and “!textFile(“b.xxx”)”, “!exeFile(“b.xxx”)”, “!hiddenmalware(“b.xxx”)”, and “harmlessUnknownFile(“b.xxx”)” have been observed as an observation O′. If the data specifying unit 12 performs an analysis (backward inference) on the observation P using the above-described knowledge data, in this case, “textFile(“b.xxx”)”, “exeFile(“b.xxx”)”, and “unknownTypeFile(“b.xxx”)” are obtained.

Incidentally, in the example in FIG. 4, although “!textFile(“b.xxx”)”, “!exeFile(“b.xxx”)”, “!hiddenmalware(“b.xxx”)”, and “harmlessUnknownFile(“b.xxx”)” are included in the other observed event data O′, “unknownTypeFile(“b.xxx”)” is not included. Therefore, in the example in FIG. 4, the observation P is not specified as unneeded observed event data. Note that, in the following, the affirmative literal (“exeFile(“b.xxx”)” and the like) is treated as the same as the negation literal (“!exeFile(“b.xxx”)” and the like).

In contrast, in the example in FIG. 5, the data specifying unit 12 performs backward inference with respect to “unknownTypeFile(“b.xxx”)”, which is a previous inference result, based on “hiddenMalware(x)⇒unknownTypeFile(x)” and “harmlessUnknownFile(x)⇒unknownTypeFile(x)” as the knowledge data. With this, “hiddenMalware(“b.xxx”)” and “harmlessUnknownFile(“b.xxx”)” are acquired. Also, because these are included in the other observed event data O′, the data specifying unit 12 specifies the observation P as unneeded observed event data. Note that, in FIG. 5, the literals surrounded by solid lines indicate observed literals, and the literals surrounded by broken lines indicate unobserved literals.

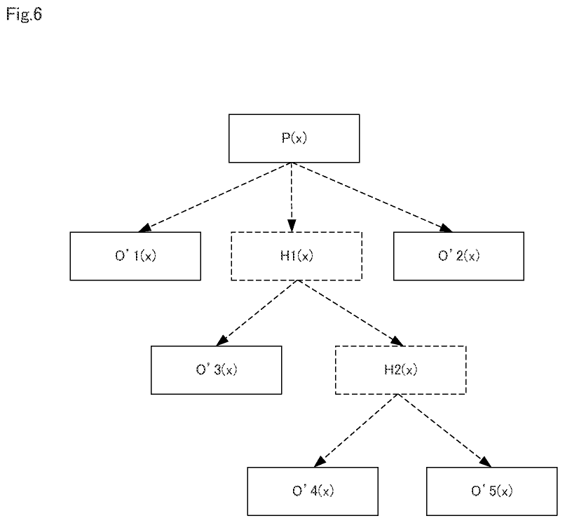

FIG. 6 shows a directed graph formed by backward inference from the observation P. In the directed graph shown in FIG. 6, when movement is performed according to the directions of the links from the observation P, if any of the literals of the observation O′ can be necessarily reached, it is possible to specify the observation P as unneeded observed event data.

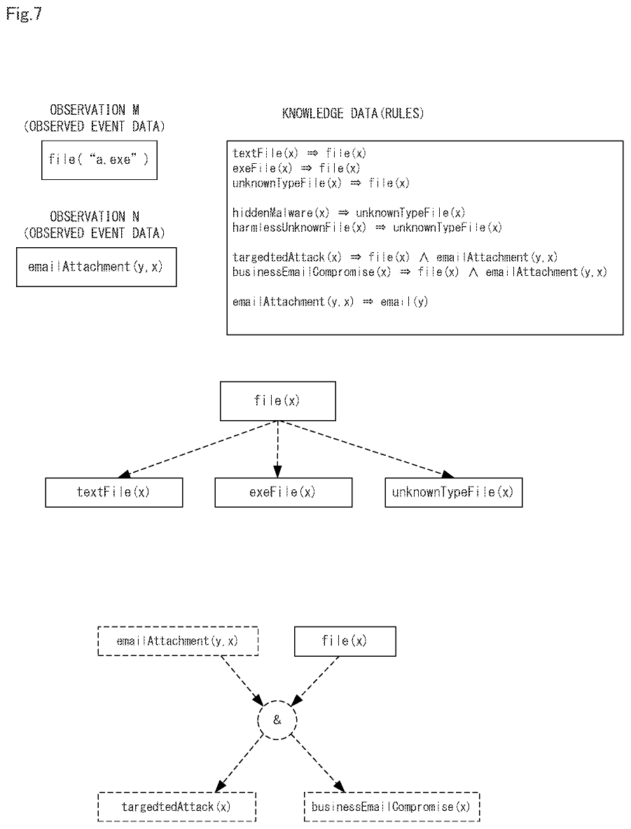

FIG. 7 is a diagram illustrating a specific example 3 of step 2 shown in FIG. 3. In the example in FIG. 7, the condition is that whether or not received observed event data and an event expected to be observed hold true at the same time. In other words, in the example in FIG. 7, the condition is that a rule is present that includes a consequent in which an observation logical formula included in observed event data and an observation logical formula indicating an event expected to be observed forms a conjunction. “targedtedAttack(x) ⇒file(x)\hat{ }emailAttachment(y,x)” and “businessEmailCompromise(x)⇒file(x)\hat{ }emailAttachment(y,x)”, of the above-described knowledge data, correspond to the rule that includes a consequent in which literals form a conjunction.

Also, the data specifying unit 12 specifies, under this condition, the received observed event data as unneeded observed event data if the event expected to be observed has not been observed, or if the event expected to be observed cannot be derived by backward inference from other observations based on the knowledge data.

Specifically, in the example in FIG. 7, it is assumed that “file(“a.exe”)” has been observed as an observation M. Also, it is assumed that the event expected to be observed is an observation N “emailAttachment(y,x)”. In this case, as a result of backward inference of the observation using the above-described knowledge data, the tree shown in the middle part of FIG. 7 is obtained. This tree shows a directed graph formed by backward inference from an observation “file(“a.exe”)”. The tree shown in the lower part of FIG. 7 shows a directed graph formed by backward inference from the observations M and N. Note that the conjunction is expressed by using a symbol “&” in FIG. 7.

Under this condition, it is assumed that observed event data “!textFile(“a.exe”)”, “exeFile(“a.exe”)”, and “!unknownTypeFile(“a.exe”)” have been observed as an observation O′, similar to the example in FIG. 4. On the other hand, it is assumed that “targedtedAttack(x)” and “businessEmailCompromise(x)” have not been observed. Here, if an observation N “emailAttachment(y,x)” that is expected to be observed has not been observed, or if the observation N cannot be acquired as a hypothesis by backward inference based on the knowledge data from the observation M or O′, the data specifying unit 12 specifies the observation M as unneeded observed event data.

Also, in other words, if “emailAttachment(“c.emal”,“a.exe”)” has been observed as the observation N in addition to the observations M and O′, the observation M cannot be specified as unneeded observed event data. Also, if “email(“c.eml”)” has been observed as the observation, the observation N “emailAttachment(“c.eml”,x)” is hypothetically inferred with the rule “emailAttachment(y,x)⇒email(y)”. Therefore, in this case as well, the observation M cannot be specified as unneeded observed event data.

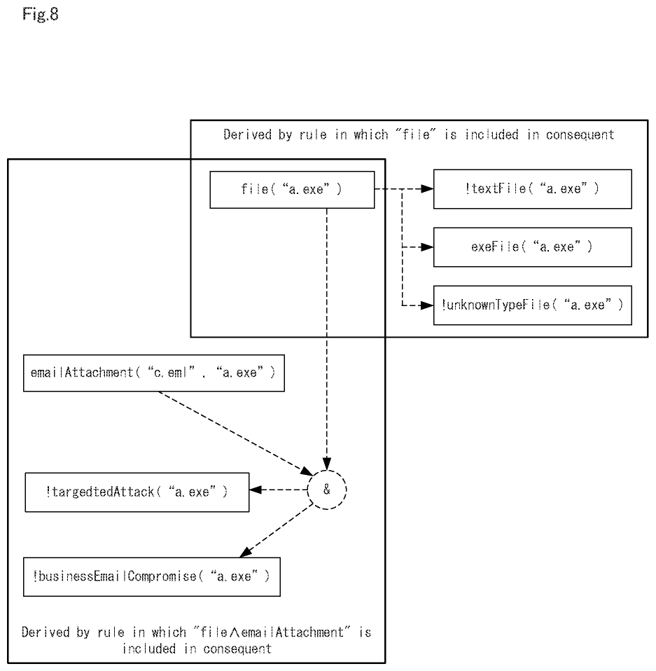

Note that, in the example in FIG. 7, even if “emailAttachment(“c.emal”,“a.exe”)” has been observed, if “!targedtedAttack(“a.exe”)” and “!businessEmailCompromise(“a.exe”)” have been observed, the directed graph shown in FIG. 8 holds true. FIG. 8 is a diagram illustrating a specific example 4 of step 2 shown in FIG. 3.

As shown in FIG. 8, in this case, the observation M “file(“a.exe”)” can be derived from the rule that includes “file\hat{ }emailAttachment” in the consequent, and the rule that includes “file” in the consequent. Therefore, in the example in FIG. 8, the observation M is specified as unneeded observed event data.

### Effects According to Present Example Embodiment

As described above, according to the present example embodiment, abductive inference can be executed in a state of excluding unneeded observed event data. Also, the unneeded observed event data to be excluded is strictly specified based on a newly acquired observation, an observation that has been already acquired, and the knowledge data. Therefore, according to the present example embodiment, the accuracy of a hypothesis can be improved while suppressing the increase in time needed to derive the hypothesis.

[Program]

A program according to the present example embodiment need only be a program for causing a computer to perform steps A1 to A4 shown in FIG. 3. The abductive inference apparatus 10 and the abductive inference method according to the present example embodiment can be realized by installing this program on a computer and executing the program. In this case, a processor of the computer functions as the data receiving unit 11, the data specifying unit 12, and the hypothesis generation unit 13, and performs processing.

Also, the program according to the present example embodiment may also be executed by a computer system that includes a plurality of computers. In this case, for example, each of the computers may function as any of the data receiving unit 11, the data specifying unit 12, and the hypothesis generation unit 13.

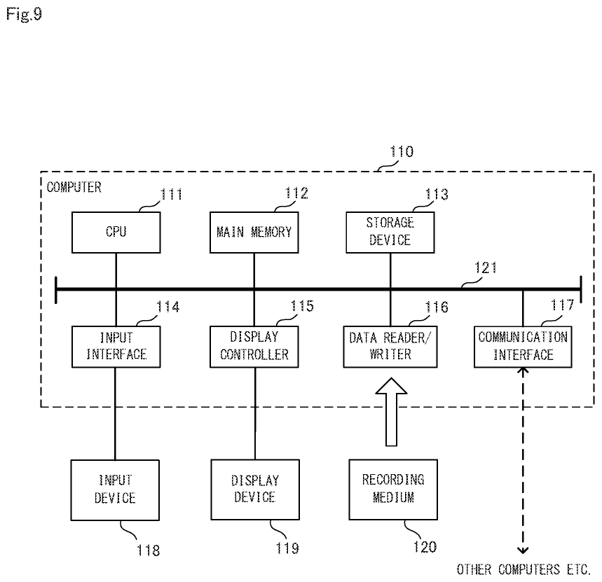

A description will now be given, with reference to FIG. 9, of a computer that realizes the abductive inference apparatus 10 by executing the program according to the present example embodiment. FIG. 9 is a block diagram illustrating an example of a computer that realizes the abductive inference apparatus according to the present example embodiment of the invention.

As shown in FIG. 9, a computer 110 includes a CPU 111, a main memory 112, a storage device 113, an input interface 114, a display controller 115, a data reader/writer 116, and a communication interface 117. These units are connected to each other via a bus 121 so as to be able to communicate data. Note that the computer 110 may also include, in addition to the CPU 111 or in place of the CPU 111, a GPU (Graphics Processing Unit), or an FPGA (Field-Programmable Gate Array).

The CPU 111 loads the program (codes) according to the present example embodiment that is stored in the storage device 113 to the main memory 112 and executes the codes in a predetermined order, thereby performing various kinds of computation. The main memory 112 is typically a volatile storage device such as a DRAM (Dynamic Random Access Memory). The program according to the present example embodiment is provided in a state of being stored in a computer-readable recording medium 120. Note that the program according to the present example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

Note that the abductive inference apparatus 10 according to the present example embodiment may also be realized using hardware that corresponds to each of the units, rather than a computer in which the program is installed. Furthermore, the abductive inference apparatus 10 may be partially realized by a program, and the remainder may be realized by hardware.

Part of, or the entire present example embodiment described above can be expressed by the following (Supplementary note 1) to (Supplementary note 15), but is not limited thereto.

(Supplementary Note 1)

An abductive inference apparatus including:

a data receiving unit configured to receive observed event data indicating an observed event;

a data specifying unit configured to specify observed event data that will not be needed from the received pieces of observed event data based on pieces of observed event data other than the received pieces of observed event data and knowledge data; and

a hypothesis generation unit configured to generate a hypothesis with which the observed event data that has not been specified by the data specifying unit can be derived using the pieces of observed event data that have not been specified by the data specifying unit and the knowledge data.

(Supplementary Note 2)

The abductive inference apparatus according to supplementary note 1,

wherein the data specifying unit performed an analysis on the pieces of received observed event data based on the knowledge data, and specifies observed event data that can be derived from the analysis result and the other pieces of observed event data as the observed event data that will not be needed.

(Supplementary Note 3)

The abductive inference apparatus according to supplementary note 1 or 2,

wherein the data specifying unit performs backward inference on the received observed event data, and specifies the received observed event data as the observed event data that will not be needed on a condition that, with respect to the obtained inference result, when the inference is traced back from the received observed event data, any of the other pieces of observed event data are necessarily reached.

(Supplementary Note 4)

The abductive inference apparatus according to any of supplementary notes 1 to 3,

wherein the data specifying unit specifies, on a condition that the received observed event data and an event expected to be observed hold true at the same time, that the received observed event data as the observed event data that will not be needed if the event expected to be observed has not been observed, or if the event expected to be observed cannot be derived by backward inference from another observation based on the knowledge data.

(Supplementary Note 5)

The abductive inference apparatus according to any of supplementary notes 1 to 4,

wherein the data receiving unit receive a log output from a computer system as the observed event data,

the data specifying unit specifies a log that will not be needed, from the received logs, based on logs other than the received logs and knowledge data,

the hypothesis generation unit generates a hypothesis with which the log that has not been specified in the (b) step can be derived using the logs that have not been specified by the data specifying unit and the knowledge data, and

the abductive inference apparatus further includes an anomaly information generation unit configured to create information regarding an anomaly that has occurred in the computer system based on the generated hypothesis, and output the created information to the outside.

(Supplementary Note 6)

An abductive inference method, including:

(a) a step of receiving observed event data indicating an observed event;

(b) a step of specifying observed event data that will not be needed from the received pieces of observed event data based on pieces of observed event data other than the received pieces of observed event data and knowledge data; and

(c) a step of generating a hypothesis with which the observed event data that has not been specified in the (b) step can be derived using the pieces of observed event data that have not been specified in the (b) step and the knowledge data.

(Supplementary Note 7)

The abductive inference method according to supplementary note 6,

wherein, in the (b) step, an analysis is performed on the pieces of received observed event data based on the knowledge data, and observed event data that can be derived from the analysis result and the other pieces of observed event data is specified as the observed event data that will not be needed.

(Supplementary Note 8)

The abductive inference method according to supplementary note 6 or 7,

wherein, in the (b) step, backward inference is performed on the received observed event data, and the received observed event data is specified as the observed event data that will not be needed on a condition that, with respect to the obtained inference result, when the inference is traced back from the received observed event data, any of the other pieces of observed event data are necessarily reached.

(Supplementary Note 9)

The abductive inference method according to any of supplementary notes 6 to 8,

wherein, in the (b) step, the received observed event data is specified as the observed event data that will not be needed, on a condition that the received observed event data and an event expected to be observed hold true at the same time, if the event expected to be observed has not been observed, or if the event expected to be observed cannot be derived by backward inference from another observation based on the knowledge data.

(Supplementary Note 10)

The abductive inference method according to any of supplementary notes 6 to 9,

wherein, in the (a) step, a log output from a computer system is received as the observed event data,

in the (b) step, a log that will not be needed is specified, from the received logs, based on logs other than the received logs and knowledge data,

in the (c) step, a hypothesis with which the log that has not been specified by the data specifying unit can be derived is generated using the logs that have not been specified in the (b) step and the knowledge data, and

the abductive inference method further includes:

(d) a step of creating information regarding an anomaly that has occurred in the computer system based on the generated hypothesis, and outputting the created information to the outside.

(Supplementary Note 11)

A computer-readable recording medium that includes a program recorded thereon, the program including instructions that cause the computer to carry out:

(a) a step of receiving observed event data indicating an observed event;

(b) a step of specifying observed event data that will not be needed from the received pieces of observed event data based on pieces of observed event data other than the received pieces of observed event data and knowledge data; and

(c) a step of generating a hypothesis with which the observed event data that has not been specified in the (b) step can be derived using the pieces of observed event data that have not been specified in the (b) step and the knowledge data.

(Supplementary Note 12)

The computer readable recording medium according to supplementary note 11,

wherein, in the (b) step, an analysis is performed on the pieces of received observed event data based on the knowledge data, and observed event data that can be derived from the analysis result and the other pieces of observed event data is specified as the observed event data that will not be needed.

(Supplementary Note 13)

The computer readable recording medium according to supplementary note 11 or 12,

wherein, in the (b) step, backward inference is performed on the received observed event data, and the received observed event data is specified as the observed event data that will not be needed on a condition that, with respect to the obtained inference result, when the inference is traced back from the received observed event data, any of the other pieces of observed event data are necessarily reached.

(Supplementary Note 14)

The computer readable recording medium according to any of supplementary notes 11 to 13,

wherein, in the (b) step, the received observed event data is specified as the observed event data that will not be needed, on a condition that the received observed event data and an event expected to be observed hold true at the same time, if the event expected to be observed has not been observed, or if the event expected to be observed cannot be derived by backward inference from another observation based on the knowledge data.

(Supplementary Note 15)

The computer readable recording medium according to any of supplementary notes 11 to 14,

wherein, in the (a) step, a log output from a computer system is received as the observed event data,

in the (b) step, a log that will not be needed is specified, from the received logs, based on logs other than the received logs and knowledge data,

in the (c) step, a hypothesis with which the log that has not been specified in the (b) step can be derived is generated using the logs that have not been specified in the (b) step and the knowledge data, and

the program further includes instructions that cause the computer to carry out:

(d) a step of creating information regarding an anomaly that has occurred in the computer system based on the generated hypothesis, and outputting the created information to the outside.

The invention of the present application has been described above with reference to the present example embodiment, but the invention of the present application is not limited to the above present example embodiment. The configurations and the details of the invention of the present application may be changed in various manners that can be understood by a person skilled in the art within the scope of the invention of the present application.

### INDUSTRIAL APPLICABILITY

As described above, according to the invention, abductive inference can be executed while excluding unneeded observed event data. The invention is useful in a system in which abductive inference is required.

### LIST OF REFERENCE SIGNS

10 Abductive inference apparatus
11 Data receiving unit
12 Data specifying unit
13 Hypothesis generation unit
110 Computer
111 CPU
112 Main memory
113 Storage device
114 Input interface
115 Display controller
116 Data reader/writer
117 Communication interface
118 Input devices
119 Display device
120 Recording medium
121 Bus

What is claimed is:

1. An abductive inference apparatus comprising:
a data receiving unit that configured to receive observed event data indicating an observed event;
a data specifying unit that configured to specify observed event data that will not be needed from the received pieces of observed event data based on pieces of observed event data other than the received pieces of observed event data and knowledge data; and
a hypothesis generation unit that configured to generate a hypothesis with which the observed event data that has not been specified by the data specifying unit can be derived using the pieces of observed event data that have not been specified by the data specifying unit and the knowledge data.

2. The abductive inference apparatus according to claim 1,
wherein the data specifying unit performs an analysis on the pieces of received observed event data based on the knowledge data, and specifies observed event data that can be derived from the analysis result and the other pieces of observed event data as the observed event data that will not be needed.

3. The abductive inference apparatus according to claim 1,
wherein the data specifying unit performs backward inference on the received observed event data, and specifies the received observed event data as the observed event data that will not be needed on a condition that, with respect to the obtained inference result, when the inference is traced back from the received observed event data, any of the other pieces of observed event data are necessarily reached.

4. The abductive inference apparatus according to claim 1,
wherein the data specifying unit specifies, on a condition that the received observed event data and an event expected to be observed hold true at the same time, that the received observed event data as the observed event data that will not be needed if the event expected to be observed has not been observed, or if the event expected to be observed cannot be derived by backward inference from another observation based on the knowledge data.

5. The abductive inference apparatus according to claim 1,
wherein the data receiving unit receives a log output from a computer system as the observed event data,
the data specifying unit specifies a log that will not be needed, from the received logs, based on logs other than the received logs and knowledge data,
the hypothesis generation unit generates a hypothesis with which the log that has not been specified by the data specifying unit can be derived using the logs that have not been specified by the data specifying unit and the knowledge data, and
the abductive inference apparatus further comprises an anomaly information generation unit that configured to create information regarding an anomaly that has occurred in the computer system based on the generated hypothesis, and output the created information to the outside.

6. An abductive inference method, comprising:
receiving observed event data indicating an observed event;
specifying observed event data that will not be needed from the received pieces of observed event data based on pieces of observed event data other than the received pieces of observed event data and knowledge data; and
generating a hypothesis with which the observed event data that has not been specified in the specifying can be derived using the pieces of observed event data that have not been specified in the specifying and the knowledge data.

7. The abductive inference method according to claim 6,
wherein, in the specifying, an analysis is performed on the pieces of received observed event data based on the knowledge data, and observed event data that can be derived from the analysis result and the other pieces of observed event data is specified as the observed event data that will not be needed.

8. The abductive inference method according to claim 6,
wherein, in the specifying, backward inference is performed on the received observed event data, and the received observed event data is specified as the observed event data that will not be needed on a condition that, with respect to the obtained inference result, when the inference is traced back from the received observed event data, any of the other pieces of observed event data are necessarily reached.

9. The abductive inference method according to claim 6,
wherein, in the specifying, the received observed event data is specified as the observed event data that will not be needed, on a condition that the received observed event data and an event expected to be observed hold true at the same time, if the event expected to be observed has not been observed, or if the event expected to be observed cannot be derived by backward inference from another observation based on the knowledge data.

10. The abductive inference method according to claim 6,
wherein, in the receiving, a log output from a computer system is received as the observed event data,
in the specifying, a log that will not be needed is specified, from the received logs, based on logs other than the received logs and knowledge data,
in the generating, a hypothesis with which the log that has not been specified in the specifying can be derived is generated using the logs that have not been specified in the (b) step and the knowledge data, and
the abductive inference method further comprises:
creating information regarding an anomaly that has occurred in the computer system based on the generated hypothesis, and outputting the created information to the outside.

11. A non-transitory computer-readable recording medium that includes a program recorded thereon, the program including instructions that cause the computer to carry out:
receiving observed event data indicating an observed event;
specifying observed event data that will not be needed from the received pieces of observed event data based on pieces of observed event data other than the received pieces of observed event data and knowledge data; and
generating a hypothesis with which the observed event data that has not been specified in the specifying can be derived using the pieces of observed event data that have not been specified in the specifying and the knowledge data.

12. The non-transitory computer readable recording medium according to claim 11,
wherein, in the specifying, an analysis is performed on the pieces of received observed event data based on the knowledge data, and observed event data that can be derived from the analysis result and the other pieces of observed event data is specified as the observed event data that will not be needed.

13. The non-transitory computer readable recording medium according to claim 11,
wherein, in the specifying, backward inference is performed on the received observed event data, and the received observed event data is specified as the observed event data that will not be needed on a condition that, with respect to the obtained inference result, when the inference is traced back from the received observed event data, any of the other pieces of observed event data are necessarily reached.

14. The non-transitory computer readable recording medium according to claim 11,
wherein, in the specifying, the received observed event data is specified as the observed event data that will not be needed, on a condition that the received observed event data and an event expected to be observed hold true at the same time, if the event expected to be observed has not been observed, or if the event expected to be observed cannot be derived by backward inference from another observation based on the knowledge data.

15. The non-transitory computer readable recording medium according to claim 11,
wherein, in the receiving, a log output from a computer system is received as the observed event data,
in the specifying, a log that will not be needed is specified, from the received logs, based on logs other than the received logs and knowledge data,
in the generating, a hypothesis with which the log that has not been specified in the (b) step can be derived is generated using the logs that have not been specified in the (b) step and the knowledge data, and
the program further includes instructions that cause the computer to carry out:
creating information regarding an anomaly that has occurred in the computer system based on the generated hypothesis, and outputting the created information to the outside.
